(19) United States
(12) Patent Application Publication
(10) Pub. No.: US 2005/0281228 A1
(43) Pub. Date: Dec. 22, 2005

(54) System for soft handover in MIMO OFDMA mobile communication system and method thereof

(75) Inventors: Jeong-Tae Oh, Yongin-si (KR); Won-II Roh, Yongin-si (KR); Kyun-Byoung Ko, Goyang-si (KR); Jae-Ho Jeon, Seongnam-si (KR); Seung-Joo Maeng, Seongnam-si (KR); Pan-Yuh Joo, Yongin-si (KR); Hong-Sil Jeong, Suwon-si (KR); Sung-Ryul Yun, Suwon-si (KR); Chan-Byoung Chae, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/158,861

(22) Filed: Jun. 22, 2005

(30) Foreign Application Priority Data
Jun. 22, 2004 (KR) 2004-46780

(51) Int. Cl. H04Q 7/20

(52) U.S. Cl. 370/331; 370/329

(57) ABSTRACT

Disclosed is a method for performing a soft handover in a Multiple Input Multiple Output (MIMO) Orthogonal Frequency Division Multiple Access (OFDMA) mobile communication system including a mobile station (MS), a serving base station (BS) and a plurality of neighbor BSs, each neighbor BS being different from the serving BS the serving BS providing a service to the MS. According to the method, the MS requests a soft handover to the serving BS when the serving BS detects that the MS must be handed over to one of the neighbor BSs, the serving BS notifies the neighbor BSs of the soft handover of the MS in response to the request for the soft handover, transmits signals to the MS using a predetermined coding scheme and a predetermined frequency region allocation scheme, and the neighbor BSs transmit signals to the MS using the predetermined coding scheme and the predetermined frequency region allocation scheme.

### PRIORITY

This application claims priority under 35 U.S.C. § 119 to an application entitled “System for Soft Handover in MIMO OFDMA Mobile Communication System and Method Thereof” filed in the Korean Intellectual Property Office on Jun. 22, 2004 and assigned Serial No. 2004-46780, the contents of which are hereby incorporated by reference.

### BACKGROUND OF THE INVENTION

1. Field of the Invention

The present invention relates generally to an Orthogonal Frequency Division Multiple Access (OFDMA) mobile communication system, and more particularly to a system and a method for performing a soft handover in an OFDMA mobile communication system using a Multiple Input Multiple Output (MIMO) scheme.

2. Description of the Related Art

Generally, in the wireless channel environments of mobile communication systems, unavoidable errors occur due to various factors such as multi-path interference, shadowing, electric wave attenuation, time-varying noise, interference and fading. These errors may contribute to the loss of data. A diversity scheme can be used in order to remove instability of communication due to the fading. The diversity scheme may be classified into a time diversity scheme, a frequency diversity scheme and an antenna diversity scheme, that is, a space diversity scheme. A MIMO scheme is a special type of the antenna diversity scheme and a type of Space-Time Coding (STC) scheme. The STC scheme is a type of predetermined coding scheme. That is, according to the STC scheme, coded signals are transmitted through a plurality of transmission antennas, so that a coding scheme on a time domain is expanded to a space domain, thereby achieving a low error rate. As a result, when the MIMO scheme is used, it is possible to acquire a relatively high transmit gain by means of a transmit antenna diversity scheme, a Spatial Multiplexing (SM) scheme, etc. The transmit antenna diversity scheme, the coding SM scheme, etc., may have different gains according to states of wireless channels in which the transmit antenna diversity scheme and the SM scheme are actually used.

A handover scheme represents scheme for providing a service to a Mobile Station (MS) without discontinuity by switching a communication from a serving Base Station (BS) to a neighbor BS when the MS moves into a boundary region of a the serving BS's cell, with which the MS is communicating, and approaches the neighbor BS cell. Further, in order to solve a problem in that reception performance of an MS deteriorates during a handover, a mobile communication system (e.g., a Code Division Multiple Access (CDMA) mobile communication system) using a CDMA scheme uses a soft handover scheme for simultaneously receiving signals transmitted from a current serving BS and a future serving BS, that is, a target BS, and improving quality of received signals.

FIG. 1 is a block diagram schematically illustrating a conventional soft handover operation in a mobile communication system. The mobile communication system has a multi-cell structure, e.g., a first cell 101 and a second cell 102. Further, the mobile communication system includes a first BS 103 that controls the first cell 101, a second BS 104 that controls the second cell 102, and an MS 105. The MS 105 exists in a boundary region 106 located between the first cell 101 and the second cell 102. In the boundary region 106, wherein transmission/reception performance of MS 105 deteriorates. That is, signals received from the first BS 103, which is a serving BS currently providing a service to the MS 105, have reduced intensities and signals received from the second BS 104 (neighbor BS) function as interference signals for the MS 105. Therefore, it becomes more difficult for the MS 105 to receive signals of desired quality. In order to ensure quality of signals received in the MS 105, a CDMA mobile communication system employs soft handover scheme.

Hereinafter, the soft handover scheme will be described in detailed. First, when the MS 105 is located in a boundary region 106 (also known as a soft handover region 106), which is the overlapping region between the first cell 101 and the second cell 102, the MS 105 requests a soft handover to the first BS 103 (serving BS). Then, the first BS 103 and the second BS 104 transmit the same (i.e., identical) data to the MS 105 in response to the soft handover request. The MS 105 receives the same data from the first BS 103 and the second BS 104, and combines and demodulates the same data. The first BS 103 and the second BS 104 transmit the data by means of specific Pseudorandom Noise (PN) codes, respectively, so that the MS 105 can separately demodulate the same data transmitted from the first BS 103 and the second BS 104. However, because an OFDMA mobile communication system does not use the CDMA scheme, it is difficult to separate the same data transmitted from neighbor BSs in soft handover of an MS. Therefore, performance of the soft handover scheme cannot be ensured.

### SUMMARY OF THE INVENTION

Accordingly, the present invention has been made to solve the above-mentioned problems occurring in the prior art, and it is an object of the present invention is to provide a system and a method for performing a soft handover in an OFDMA mobile communication system using a MIMO scheme.

In order to accomplish the aforementioned object, according to one aspect of the present invention, there is provided a system for performing a soft handover in an MIMOOFDMA mobile communication system, the system including a mobile station, a serving base station for transmitting signals to the mobile station by means of a predetermined coding scheme and a predetermined frequency region allocation scheme when detecting that the mobile station must perform the soft handover, and a plurality of neighbor base stations for transmitting signals to the mobile station by means of the predetermined coding scheme and the predetermined frequency region allocation scheme when detecting that the mobile station must perform the soft handover.

In order to accomplish the aforementioned object, according to a second aspect of the present invention, there is provided a method for performing a soft handover by a serving base station providing a service to a mobile station in an MIMO OFDMA mobile communication system including a plurality of neighbor base stations different from the serving base station, the method including the steps of determining whether the mobile station must perform the soft handover, and transmitting signals to the mobile station by using a predetermined coding scheme and a predetermined frequency region allocation scheme.

In order to accomplish the aforementioned object, according to a third aspect of the present invention, there is provided a method for performing a soft handover by a plurality of neighbor base stations in an MIMO OFDMA mobile communication system including a mobile station, a serving base station, and the plurality of neighbor base stations, each of the plurality of neighbor base different from the serving base station, the serving base station providing a service to the mobile station, the method including the steps of detecting that the mobile station must perform the soft handover, and transmitting signals to the mobile station by means of a predetermined coding scheme and a predetermined frequency region allocation scheme.

In order to accomplish the aforementioned object, according to a fourth aspect of the present invention, there is provided a method for performing soft handover by a mobile station in an MIMO OFDMA mobile communication system including a serving base station and a plurality of neighbor base stations, each of the plurality of neighbor base stations being different from the serving base station, the serving base station providing a service to the mobile station, the method including the steps of requesting a soft handover to the serving base station when the serving base station detects that the mobile station must be handed over to one of the neighbor base station; and receiving and combining signals from the serving base station and the neighbor base stations after requesting the soft handover to the serving base station, and decoding the combined signals by means of schemes corresponding to a coding scheme and a frequency region allocation scheme applied to the serving base station and the neighbor base stations.

In order to accomplish the aforementioned object, according to a fifth aspect of the present invention, there is provided a method for performing a soft handover in an MIMO OFDMA mobile communication system including a mobile station, a serving base station and a plurality of neighbor base stations, each of the plurality of neighbor base stations being different from the serving base station, the serving base station providing a service to the mobile station, the method including the steps of requesting, by the mobile station to the serving base station a soft handover when the serving base station detects that the mobile station must be handed over to one of the neighbor base stations, notifying, by the serving base station, the neighbor base stations of the soft handover of the mobile station in response to the request for the soft handover, transmitting signals by the serving base station to the mobile station by means of a predetermined coding scheme and a predetermined frequency region allocation scheme, and transmitting signals by the plurality of neighbor base stations to the mobile station by means of the predetermined coding scheme and the predetermined frequency region allocation scheme.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a conventional soft handover operation in a mobile communication system;

FIG. 2 is a block diagram schematically illustrating a data transmission operation by a BS using a plurality of transmit antennas;

FIG. 3 is a block diagram schematically illustrating a soft handover operation according to an embodiment of the present invention in a MIMO OFDMA mobile communication system including two BSs;

FIG. 4 is a block diagram schematically illustrating a soft handover operation according to an embodiment of the present invention in a MIMO OFDMA mobile communication system including N of BSs;

FIG. 5A is a diagram illustrating a bitmap according to the embodiment of the present invention shown in FIG. 4.

FIG. 5B is a diagram illustrating a bitmap when only a simulcast scheme is used in the bitmap structure shown in FIG. 5A;

FIG. 5C is a diagram illustrating a bitmap when only a diversity combining scheme is used in the bitmap structure of FIG. 5A; and

FIG. 5D is a diagram illustrating a bitmap when a simulcast scheme, a diversity combining scheme and a data rate scheme are synthetically used in the bitmap structure of FIG. 5A.

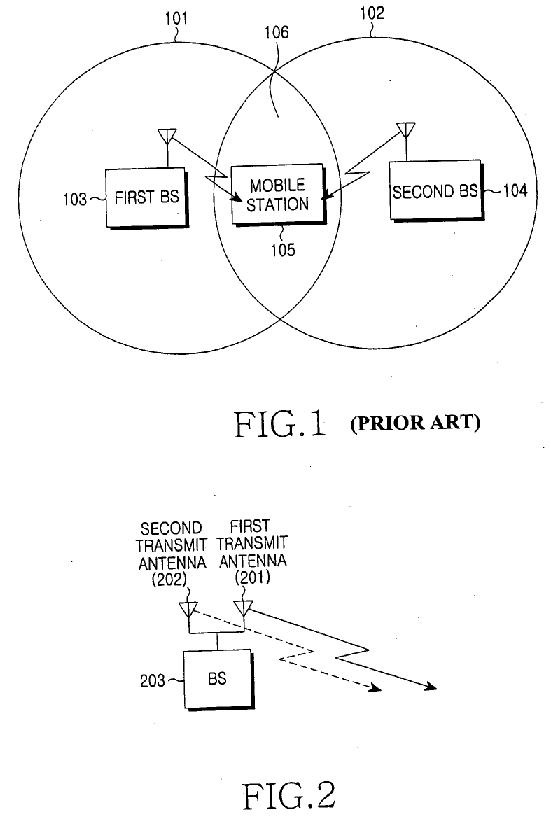

### DETAILED DESCRIPTION OF THE PREFERRED EMBODIMENT

Hereinafter, a preferred embodiment according to the present invention will be described with reference to the accompanying drawings. The same reference numerals are used to designate the same elements as those shown in other drawings. In the following description of the present invention, a detailed description of known functions and configurations incorporated herein will be omitted when it may make the subject matter of the present invention unclear.

The present invention discloses a system and a method for performing a soft handover in an Orthogonal Frequency Division Multiple Access (OFDMA) mobile communication system using a Multiple Input Multiple Output (MIMO) scheme.

Specifically, the present invention proposes a system and a method for performing a soft handover in a MIMO OFDMA mobile communication system by employing an exemplary case in which a transmitter, e.g., a Base Station (BS), transmits signals to a receiver, e.g., a Mobile Station (MS), by means of a Space-Time Block Code (STBC) coding scheme or a Spatial Multiplexing (SM) coding scheme.

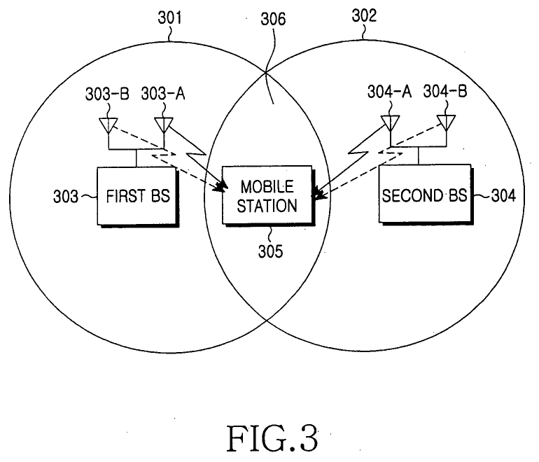

FIG. 2 is a block diagram schematically illustrating a data transmission operation by a BS using a plurality of transmit antennas. It is assumed that a BS 203 uses a plurality of transmit antennas, e.g., two transmit antennas, i.e., a first transmit antenna 201 and a second transmit antenna 202.

The first transmit antenna 201 and the second transmit antenna 202 transmit data at the same time. The data transmitted through the first transmit antenna 201 and the second transmit antenna 202 may be varied according to a coding scheme used by the BS 203.

Table 1 below shows transmission data according to transmission timing points when the BS 203 uses the STBC coding scheme.

TABLE 1

| | t | t + 1 |
|---|---|---|
| first transmit antenna 201 | S₁ | −S₂* |
| second transmit antenna 202 | S₂ | S₁* |

Referring to Table 1, using input data S₁ and S₂, the data S₁ is transmitted using the first transmit antenna 201 and the data S₂ is transmitted using the second transmit antenna 202 at a transmission timing point t. Then, at a transmission timing point t+1 (i.e., the next transmission timing point), data −S*₂ (which is a conjugate of data S₂) is transmitted using the first transmit antenna 201 and the data S*₁ (which is a conjugate of data S₁) is transmitted using the second transmit antenna 202. S*₁.

In contrast with a BS having a single transmit antenna, a BS having two transmit antennas to transmit data, transmits the data using both transmit antennas 2-1 and 202 with each transmit antenna has transmit power corresponding to half of that which would be required using the single transmit antenna of the BS having the single transmit antenna of said one transmit antenna.

Further, an MS using a plurality of transmit antennas (e.g., two or more transmit antennas), can also receive and demodulate signals transmitted from the two transmit antennas of the BS as described above, so that quality of the signals can be ensured.

Table 2 below shows transmission data according to transmission timing points when the BS 203 uses an SM coding scheme.

TABLE 2

| | t | t + 1 |
|---|---|---|
| first transmit antenna 201 | S₁ | S₃ |
| second transmit antenna 202 | S₂ | S₄ |

Referring to Table 2, when input data includes S₁, S₂, S₃ and S₄, the data S₁ is transmitted using the first transmit antenna 201 and the data S₂ is transmitted using the second transmit antenna 202 at a transmission timing point t. Then, at a transmission timing point t+1 (i.e., the next transmission timing point), the data S₃ is transmitted using the first transmit antenna 201 and the data S₄ is transmitted using the second transmit antenna 202. As described above, in a BS having two transmit antennas, each of the two transmit antennas uses a transmit power corresponding to the half of that which is used by the single transmit antenna in a BS having a single transmit antenna. Accordingly, when the BS using the two transmit antennas transmits different data through each transmit antenna, an MS must use a number of receive antennas which corresponds to the number of transmit antennas used by the BS. Furthermore, an MS using a plurality of receive antennas (i.e., two receive antennas as described above), combines and demodulates signals received from the two receive antennas, so that quality of the signals and data transmission speed can be improved.

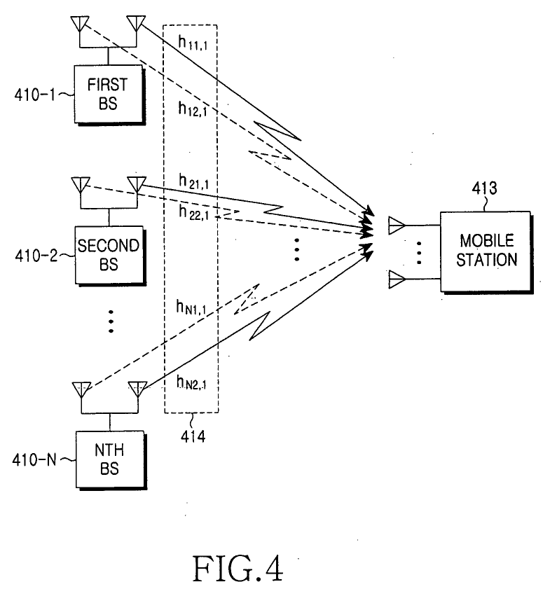

Hereinafter, a soft handover operation in an MIMO OFDMA mobile communication system according to an embodiment of the present invention will be described with reference to FIG. 3 which is a block diagram schematically illustrating the soft handover operation according to an embodiment of the present invention when an MIMO OFDMA mobile communication system includes two BSs.

Referring to FIG. 3, a first BS 303 and a second BS 304 maximize soft handover performance gain of an MS 305 by means of a plurality of transmit antennas. Although a plurality of transmit antennas can be used for each BS, BS 303 uses two transmit antennas 303A and 303B, and BS 304 uses two transmit antennas 304A and 304B a shown. Specifically, the present invention improves soft handover performance of the MIMO OFDMA mobile communication system by employing a coding scheme such as an STBC coding scheme and an SM coding scheme. That is, when the MS 305 requests a soft handover to the first BS 303, in order to support the soft handover of the MS 305 located in soft handover region 306 which is an overlapping region of a first cell 301 which is a service coverage by the first BS 303 and a second cell 302 which is a service coverage by the second BS 304, the first BS 303 and the second BS 304 code the same data using the STBC coding scheme, the SM coding scheme, and/or other coding schemes such as a hybrid coding scheme, and transmit the coded data to the MS 305.

The first BS 303 and the second BS 304 must assign a specific pilot pattern according to each transmit antenna in order to measure radio environments for said each transmit antenna. That is, all BSs of the MIMO OFDMA mobile communication system must use unique pilot patterns assigned to a first transmit antenna and to an N^{th} transmit antenna. In other words, each transmit antenna must use a unique pilot pattern which is different from pilot patterns used in other MIMO OFDMA communication systems, but, can be the same as other pilot patterns in the same MIMO OFDMA communication system.

In the MIMO OFDMA mobile communication system, each BS may also transmit data by means of different frequency regions in order to support a soft handover scheme. Herein, a scheme, in which a plurality of BSs supporting the soft handover scheme transmit the same data to a corresponding MS through a common frequency region, will be referred to as a “simulcast” scheme. A scheme, in which the BSs transmit the same data to the corresponding MS through different frequency regions, will be referred to as a “diversity combining” scheme. Further, a scheme in which the BSs transmit different data to the corresponding MS through different frequency regions, will be referred to as a “data rate improvement” scheme.

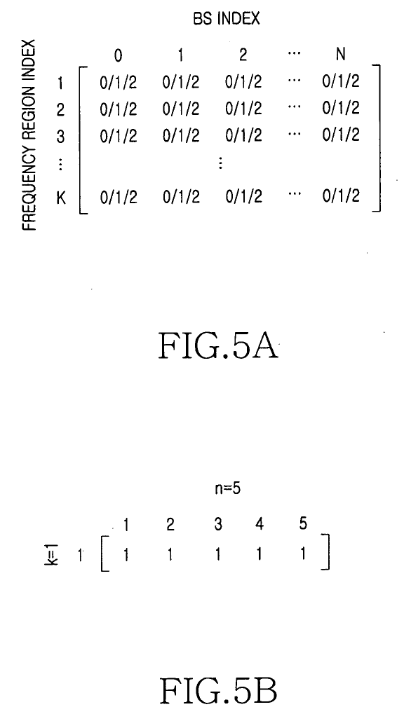

FIG. 4 is a block diagram schematically illustrating a soft handover operation according to an embodiment of the present invention when a MIMO OFDMA mobile communication system includes N number of BSs. Referring to FIG. 4, the N number of BSs, that is, a first BS 410-1 to an N^{th} BS 410-N are BSs using a plurality of transmit antennas, respectively. It is assumed that the first BS 410-1 and the n^{th} BS 410-N use two transmit antennas, respectively. FIG. 4 illustrates soft handover scheme in the MIMO OFDMA mobile communication system by employing an exemplary case in which the first BS 410-1 and the N^{th} BS 410-N each use two transmit antennas. However, in alternative embodiments, the first BS 410-1 and the N^{th} BS 410-N may also more than transmit antennas. Because the soft handover operation using an MIMO OFDMA mobile communication system including N BSs will be described in detail below, a detailed description will be omitted here.

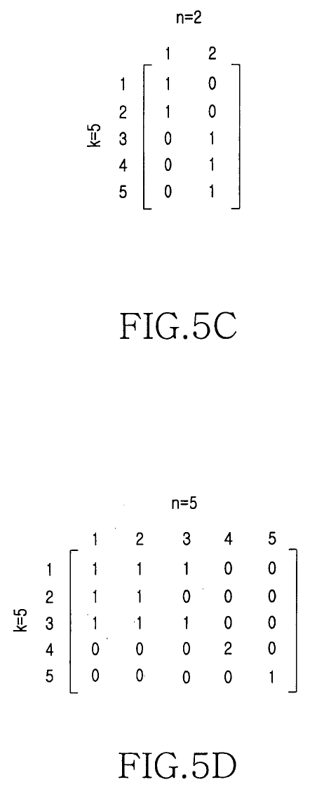

Hereinafter, a frequency allocation operation for supporting the soft handover operation when the MIMO OFDMA mobile communication system of FIG. 4 includes N BSs will be described with reference to FIGS. 5A to 5D.

FIG. 5A is a diagram illustrating a bitmap according to a frequency allocation scheme for supporting the soft handover operation when the MIMO OFDMA mobile communication system of FIG. 4 includes the N BSs.

Referring to FIG. 5A, the bitmap is expressed using a matrix in which elements of the matrix may only have a value of 0, 1 or 2. When the elements of the matrix bitmap have a value of 0, a corresponding BS does not transmit signals through a corresponding frequency region. When the elements of the bitmap have a value of 1, the corresponding BS transmits signals through the corresponding frequency region. When the elements of the bitmap have a value of 2, the corresponding BS transmits different data for a data rate improvement scheme. In the matrix, a column represents a BS index and a row represents a frequency region index. When the frequency region index is 1, transmission of the same data by the N number of BSs represents that the N number of BSs allocate frequency regions for a soft handover of a corresponding MS by means of the simulcast scheme. When a BS having the BS index of 1 transmits the same data through a plurality of frequency regions, the BS allocates a frequency region for a soft handover of a corresponding MS by means of a diversity combining scheme. Further, when the frequency region index is 1 and the BS having the BS index of 1 transmits data which is different from data transmitted by another BS, the BS allocates the frequency region for a soft handover of the corresponding MS by means of a data rate improvement scheme. The three frequency region allocation schemes described above may be simultaneously applied to one MS performing the soft handover in the form of the bitmap as illustrated in FIG. 5A.

FIG. 5b is a diagram illustrating a bitmap when only the simulcast scheme is used in the bitmap structure of FIG. 5A. The bitmap as illustrated in FIG. 5B is a bitmap in which the frequency region index is 1 and the BS index is 5 (k=1 and n=5), and five BSs transmit the same data through the same frequency region. Herein, k represents the frequency region index and n represents the BS index. In this case, because a soft handover scheme is supported through one frequency region, the efficiency of frequency resources can be improved. Further, when an MS performing the soft handover receives the same data from each of the five BSs, quality of the received signals can also be improved.

FIG. 5C is a diagram illustrating a bitmap when only the diversity combining scheme is used in the bitmap structure of FIG. 5a. The bitmap as illustrated in FIG. 5C is a bitmap in which the frequency region index is 5 and the BS index is 2 (k=5 and n=2). For example, a BS having the BS index of 1 repeatedly transmits the same data through frequency regions having the frequency region index of 1 or 2, and does not transmit any data through the remaining three frequency regions (i.e., the 3^{rd}, 4^{th} and 5^{th} frequency regions). Accordingly, because the BS does not use transmit power for the remaining three frequency regions, the BS may also increase the combined transmit power for the two frequency regions through which the data are actually transmitted by an amount up to the unused transmit power which would have been used by the frequency regions and which are presently unused. Further, a BS having the BS index of 2 repeatedly transmits the same data through frequency regions having the frequency region index of 3, 4 or 5, and does not transmit any data through the remaining two frequency regions (i.e., the first and second frequency regions). Accordingly, because the BS does not use transmit power for the first and second frequency regions, the BS may also increase transmit power for the three frequency regions through which the data are actually transmitted by an amount up to the unused transmit power which would have been used by the frequency regions which are presently unused.

FIG. 5D is a diagram illustrating a bitmap when the simulcast scheme, the diversity combining scheme and the data rate scheme are synchronously used in the bitmap structure of FIG. 5A. The bitmap as illustrated in FIG. 5D is a bitmap when the frequency region index is 5 and the BS index is 5 (k=5 and n=5). For example, a BS having the BS index of 1 transmits the same data through frequency regions having the frequency region index of 1, 2 or 3, and allocates the frequency regions by using the diversity combining scheme. Further, a BS having the BS index of 1, 2 or 3 transmits the same data through a frequency region having the frequency region index of 1, and allocates the frequency region by means of the simulcast scheme. Furthermore, a BS having the BS index of 4 transmits different data through a frequency region having the frequency region index of 4, and allocates the frequency region by means of the data rate scheme.

Hereinafter, a soft handover operation performed by an MS according to the coding scheme or the frequency region allocation scheme in the MIMO OFDMA mobile communication system, including N BSs and an MS receiving data from the N BSs and performing the soft handover as illustrated in FIG. 4, will be described in detail.

Using the STBC Coding Scheme

1. The frequency region index is 1 and the BS index is N (k=1 and n=N).

First, an operation in which the MIMO OFDMA mobile communication system as illustrated in FIG. 4 uses the simulcast scheme including the N BSs and one allocated frequency region as set forth in the bitmap as illustrated in FIG. 5A will be described hereinafter. A transmit antenna of each BS transmits the same data to the MS 413 located in the soft handover region by means of the STBC coding scheme as described in Table 1. It is assumed that the MS 413 uses P receive antennas, and the BS uses 1 transmit antennas. Signals transmitted from each transmit antenna of each BS are received in the MS 413 through radio channels 414 (shown in FIG. 4). The signals received in the MS 413 through the radio channels 414 may be expressed by Equation 1.

$${r}_{t} = ( {\sum }_{n = 1}^{N} {h}_{n1 , 1} ) \cdot {S}_{1} + ( {\sum }_{n = 1}^{N} {h}_{n2 , 1} ) \cdot {S}_{2} \\ {r}_{t + 1} = ( {\sum }_{n = 1}^{N} {h}_{n1 , 1} ) \cdot - {S}_{2}^{*} + ( {\sum }_{n = 1}^{N} {h}_{n2 , 1} ) \cdot {S}_{1}^{*} \qquad Equation 1$$

wherein h_{ni,p} represents radio channel environments between the transmit antenna of the BS and the receive antenna of the MS 413. Herein, n represents the BS index, i represents a transmit antenna index of the BS, and p represents a receive antenna index of the MS 413.

Signals rₜ and rₜ₊₁ are signals received by receive antenna of the MS 413 and represent signals formed after the signals transmitted from each BS supporting the soft handover scheme have been combined through the radio channels 414. The MS 413 estimates the combining channels

$$( {\sum }_{n = 1}^{N} {h}_{n1 , 1} ) and ( {\sum }_{n = 1}^{N} {h}_{n2 , 1} )$$

and performs an STBC decoding by using the simulcast scheme, thereby acquiring a performance gain.

Second, the frequency region index is 2 and the BS index is N (k=2 and n=N).

When N BSs and two allocated frequency regions in order to increase soft handover performance gain of the MS 413 exist, it is possible to consider a case where the simulcast scheme and the diversity combining scheme are used simultaneously. Considering a case where a frequency region having a frequency region index of 1 is allocated to BSs having the BS index of 1 to a and frequency region having a frequency region index of 2 is allocated to the other BSs, signals received by the MS 413 may be expressed by Equations 2 and 3.

$${r}_{t}^{1} = ( {\sum }_{n = 1}^{a} {h}_{n1 , 1} ) \cdot {S}_{1} + ( {\sum }_{n = 1}^{a} {h}_{n2 , 1} ) \cdot {S}_{2} \\ {r}_{t + 1}^{1} = ( {\sum }_{n = 1}^{a} {h}_{n1 , 1} ) \cdot - {S}_{2}^{*} + ( {\sum }_{n = 1}^{a} {h}_{n2 , 1} ) \cdot {S}_{1}^{*} \qquad Equation 2$$

Equation 2 represents the signals received through the frequency region having the frequency region index of 1.

$${r}_{t}^{2} = ( {\sum }_{n = a + 1}^{N} {h}_{n1 , 1} ) \cdot {S}_{1} + ( {\sum }_{n = a + 1}^{N} {h}_{n2 , 1} ) \cdot {S}_{2} \\ {r}_{t + 1}^{2} = ( {\sum }_{n = a + 1}^{N} {h}_{n1 , 1} ) \cdot - {S}_{2}^{*} + ( {\sum }_{n = a + 1}^{N} {h}_{n2 , 1} ) \cdot {S}_{1}^{*} \qquad Equation 3$$

Equation 3 represents the signals received through the frequency region having the frequency region index of 2.

In Equations 2 and 3, h_{ni,p} represents environments of the radio channels 414 between the transmit antenna of a BS and the receive antenna of a MS 413. Herein, n represents the BS index, i represents a transmit antenna index of the BS, and p represents a receive antenna index of the MS 413. Further, rₜ¹ represents the signals received in the MS 413 through a frequency region having the frequency region index of 1 at a timing point t. The signals rₜ¹ and rₜ₊₁¹ received through a frequency region having the frequency region index of 1 are used for estimating the combining channels

$$( {\sum }_{n = 1}^{a} {h}_{n1 , 1} ) and ( {\sum }_{n = 1}^{a} {h}_{n2 , 1} ) ,$$

and the signals rₜ² and rₜ₊₁² received through a frequency region having a frequency region index of 2 are used for estimating the combining channels

$$( {\sum }_{n = a + 1}^{N} {h}_{n1 , 1} ) and ( {\sum }_{n = a + 1}^{N} {h}_{n2 , 1} ) .$$

Further, the signals received through the two (n=a+1 (n=a+1 frequency regions are demodulated according to the simulcast scheme and the diversity combining scheme.

Using the SM Coding Scheme

1. The frequency region index is 1 and the BS index is N (k=1 and n=N).

First, a case where the simulcast scheme is to be used may be considered. A transmit antenna of each BS transmits the same data to the MS 413 located in the soft handover region by using of the SM coding scheme. It is assumed that the MS 413 uses the P number of receive antennas. Signals transmitted from each transmit antenna of each BS are received by the MS 413 through the radio channels 414. The signals received by the MS 413 through the radio channels 414 may be expressed by Equation 1 below.

$${r}_{t} = ( {\sum }_{n = 1}^{N} {h}_{n1 , 1} ) \cdot {S}_{1} + ( {\sum }_{n = 1}^{N} {h}_{n2 , 1} ) \cdot {S}_{2} \\ {r}_{t + 1} = ( {\sum }_{n = 1}^{N} {h}_{n1 , 1} ) \cdot {S}_{3} + ( {\sum }_{n = 1}^{N} {h}_{n2 , 1} ) \cdot {S}_{4} \qquad Equation 4$$

In Equation 4, h_{ni,p} represents environments of the radio channels 414, environments between the transmit antenna of the BS and the receive antenna of the MS 413. Herein, n represents the BS index, i represents a transmit antenna index of the BS, and p represents a receive antenna index of the MS 413.

The signals rₜ and rₜ₊₁ received in the receive antenna of the MS 413 represent signals after the signals transmitted from each BS supporting the soft handover has been combined through the radio channels 414. The MS 413 estimates the combining channels

$$( {\sum }_{n = 1}^{N} {h}_{n1 , 1} ) and ( {\sum }_{n = 1}^{N} {h}_{n2 , 1} )$$

and performs a SM decoding by the simulcast scheme, thereby acquiring a performance gain.

Second the frequency region index is 2 and the BS index is N (k=2 and n=N).

When there exist the N number of BSs and two allocated frequency regions in order to increase soft handover performance gain of the MS 413, it is possible to consider a case where the simulcast scheme and the diversity combining scheme are used simultaneously.

When a frequency regions having a frequency region index of 1 is allocated to BSs having the BS index of 1 to a and a frequency region having a frequency region index of 2 is allocated to the other BSs, signals received in the MS 413 may be expressed by Equations 5 and 6.

$${r}_{t}^{1} = ( {\sum }_{n = 1}^{a} {h}_{n1 , 1} ) \cdot {S}_{1} + ( {\sum }_{n = 1}^{a} {h}_{n2 , 1} ) \cdot {S}_{2} \\ {r}_{t + 1}^{1} = ( {\sum }_{n = 1}^{a} {h}_{n1 , 1} ) \cdot {S}_{3} + ( {\sum }_{n = 1}^{a} {h}_{n2 , 1} ) \cdot {S}_{4} \qquad Equation 5$$

Equation 5 represents the signals received through the frequency region having the frequency region index of 1.

$${r}_{t}^{2} = ( {\sum }_{n = a + 1}^{N} {h}_{n1 , 1} ) \cdot {S}_{1} + ( {\sum }_{n = a + 1}^{N} {h}_{n2 , 1} ) \cdot {S}_{2} \\ {r}_{t + 1}^{2} = ( {\sum }_{n = a + 1}^{N} {h}_{n1 , 1} ) \cdot {S}_{3} + ( {\sum }_{n = a + 1}^{N} {h}_{n2 , 1} ) \cdot {S}_{4} \qquad Equation 6$$

Equation 6 represents the signals received through the frequency region having the frequency region index of 2.

In equations 5 and 6, h_{ni,p} represents radio channel environments between the transmit antenna of the BS and the receive antenna of the MS 413. Herein, n represents the BS index, i represents a transmit antenna index of the BS, and p represents a receive antenna index of the MS 413.

Further, rₜ¹ represents the signals received in the MS 413 through the frequency region having the frequency region index of 1 at a timing point t. The signals rₜ¹ and rₜ₊₁¹ received through the frequency region having the frequency region index of 1 are used for estimating the combining channels

$$( {\sum }_{n = 1}^{a} {h}_{n1 , 1} ) and ( {\sum }_{n = 1}^{a} {h}_{n2 , 1} ) ,$$

and the signals rₜ² and rₜ₊₁¹ received through the frequency region having the frequency region index of 2 are used for estimating the combining channels

$$( {\sum }_{n = a + 1}^{N} {h}_{n1 , 1} ) and ( {\sum }_{n = a + 1}^{N} {h}_{n2 , 1} ) .$$

Further, the signals received through the two frequency regions are demodulated according to the simulcast scheme and the diversity combining scheme.

As described above, the present invention enables soft handover to be performed in a MIMO OFDMA mobile communication system, thereby improving the entire system performance.

While the present invention has been shown and described with reference to certain preferred embodiments thereof, it will be understood by those skilled in the art that various changes in form and details may be made therein without departing from the spirit and scope of the invention as defined by the appended claims.

1. A system for performing a soft handover in a Multiple Input Multiple Output (MIMO) Orthogonal Frequency Division Multiple Access (OFDMA) mobile communication system, the system comprising:
a mobile station;
a serving base station for transmitting signals to the mobile station using a predetermined coding scheme and a predetermined frequency region allocation scheme when it is detected that the mobile station must perform the soft handover; and
a plurality of neighbor base stations for transmitting signals to the mobile station using the predetermined coding scheme and the predetermined frequency region allocation scheme when it is detected that the mobile station must perform the soft handover.

2. The system as claimed in claim 1, wherein the mobile station combines signals received from the serving base station and the plurality of neighbor base stations and decodes the combined signals according to the predetermined coding scheme and the predetermined frequency region allocation scheme.

3. The system as claimed in claim 1, wherein the predetermined coding scheme includes one of a Space Time Block Code (STBC) coding scheme and a Spatial Multiplexing (SM) coding scheme.

4. The system as claimed in claim 1, wherein the serving base station and the plurality of neighbor base stations each transmit identical signals to the mobile station through identical frequency regions, when the predetermined frequency region allocation scheme is a simulcast scheme.

5. The system as claimed in claim 1, wherein the serving base station and the plurality of neighbor base stations each transmit the identical signals to the mobile station through different frequency regions when the frequency region allocation scheme is a diversity combining scheme.

6. The system as claimed in claim 1, wherein the serving base station and the plurality of neighbor base stations transmit different signals to the mobile station through different frequency regions, when the frequency region allocation scheme is a data rate improvement scheme.

7. A method for performing a soft handover by a serving base station providing service to a mobile station in a Multiple Input Multiple Output (MIMO) Orthogonal Frequency Division Multiple Access (OFDMA) mobile communication system including a plurality of neighbor base stations, each of the plurality of neighbor base stations being different from the serving base station, the method comprising the steps of:
detecting that the mobile station must perform the soft handover; and
transmitting signals to the mobile station by means of a predetermined coding scheme and a predetermined frequency region allocation scheme.

8. The method as claimed in claim 7, wherein the predetermined coding scheme includes one of a Space Time Block Code (STBC) coding scheme and a Spatial Multiplexing (SM) coding scheme.

9. The method as claimed in claim 7, wherein the step of transmitting the signals to the mobile station comprises transmitting the signals identical to signals which are transmitted from the plurality of neighbor base stations to the mobile station, through frequency regions identical to frequency regions used by the plurality of neighbor base stations, when the predetermined frequency region allocation scheme is a simulcast scheme.

10. The method as claimed in claim 7, wherein the step of transmitting the signals to the mobile station comprises transmitting signals identical to signals which are transmitted from the plurality of neighbor base stations to the mobile station, through frequency regions which are different from frequency regions used by the plurality of neighbor base stations, when the predetermined frequency region allocation scheme is a diversity combining scheme.

11. The method as claimed in claim 7, wherein the step of transmitting the signals to the mobile station comprises transmitting the signals different from signals which are transmitted from the plurality of neighbor base stations to the mobile station through frequency regions which are different from frequency regions used by the plurality of neighbor base stations, when the predetermined frequency region allocation scheme is a data rate improvement scheme.

12. A method for performing a soft handover by each of a plurality of neighbor base stations in a Multiple Input Multiple Output (MIMO) Orthogonal Frequency Division Multiple Access (OFDMA) mobile communication system including a mobile station, a serving base station, and the plurality of neighbor base stations, each of the plurality of neighbor base stations being different from the serving base station, the serving base station providing service to the mobile station, the method comprising the steps of:
detecting that the mobile station must perform the soft handover; and
transmitting signals to the mobile station by means of a predetermined coding scheme and a predetermined frequency region allocation scheme.

13. The method as claimed in claim 12, wherein the coding scheme includes one of a Space Time Block Code (STBC) coding scheme and a Spatial Multiplexing (SM) coding scheme.

14. The method as claimed in claim 12, wherein the step of transmitting the signals to the mobile station comprises transmitting signals which are identical to signals which are transmitted from the serving base station to the mobile station through frequency regions identical to frequency regions used by the serving base station, when the predetermined frequency region allocation scheme is a simulcast scheme.

15. The method as claimed in claim 12, wherein the step of transmitting the signals to the mobile station comprises transmitting signals which are identical to signals which are transmitted from the serving base station to the mobile station, through frequency regions which are different from frequency regions used by the serving base station, when the frequency region allocation scheme is a predetermined diversity combining scheme.

16. The method as claimed in claim 12, wherein the step of transmitting the signals to the mobile comprises transmitting signals which are different from signals which are transmitted from the serving base station to the mobile station through frequency regions different from frequency regions used by the serving base station, station when the predetermined frequency region allocation scheme is a data rate improvement scheme.

17. A method for soft handover by a mobile station in a Multiple Input Multiple Output (MIMO) Orthogonal Frequency Division Multiple Access (OFDMA) mobile communication system including a serving base station and a plurality of neighbor base stations, each of the plurality of neighbor base stations being different from the serving base station, the serving base station providing service to the mobile station, the method comprising the steps of:
requesting a soft handover to the serving base station when the serving base station detects that the mobile station must be handed over to one of the plurality of neighbor base stations; and
receiving and combining signals from the serving base station and the plurality of neighbor base stations after requesting the soft handover to the serving base station, and decoding the combined signals according to a coding scheme and a frequency region allocation scheme applied to the serving base station and the plurality of neighbor base stations.

18. The method as claimed in claim 17, wherein the coding scheme includes one of a Space Time Block Code (STBC) coding scheme and a Spatial Multiplexing (SM) coding scheme.

19. The method as claimed in claim 17, wherein the step of receiving the signals from the serving base station and the plurality of neighbor base stations comprises receiving the identical signals which are transmitted from the serving base station and the plurality of neighbor base stations through equal frequency regions when the frequency region allocation scheme is a simulcast scheme.

20. The method as claimed in claim 17, wherein the step of receiving the signals from the serving base station and the neighbor base stations comprises receiving identical signals which are transmitted from the serving base station and the plurality of neighbor base stations through different frequency regions when the frequency region allocation scheme is a diversity combining scheme.

21. The method as claimed in claim 17, wherein the step of receiving the signals from the serving base station and the neighbor base stations comprises receiving different signals from the serving base station and the plurality of neighbor base stations through different frequency regions when the frequency region allocation scheme is a data rate improvement scheme.

22. A method for soft handover in a Multiple Input Multiple Output (MIMO) Orthogonal Frequency Division Multiple Access (OFDMA) mobile communication system including a mobile station, a serving base station and a plurality of neighbor base stations, each of the plurality of neighbor base stations being different from the serving base station, the serving base station providing service to the mobile station, the method comprising the steps of:
requesting a soft handover by the mobile station to the serving base station when the serving base station detects that the mobile station must be handed over to one of the neighbor base stations;
notifying, by the serving base station, the plurality of neighbor base stations of the soft handover of the mobile station in response to the request for the soft handover;
transmitting signals by the serving base station to the mobile station by means of a predetermined coding scheme and a predetermined frequency region allocation scheme; and
transmitting signals by the plurality of neighbor base stations to the mobile station using the predetermined coding scheme and the predetermined frequency region allocation scheme.

23. The method as claimed in claim 22, wherein the mobile station receives and combines the signals from the serving base station and the plurality of neighbor base stations after requesting the soft handover to the serving base station, and decodes the combined signals according to the predetermined coding scheme and the predetermined frequency region allocation scheme applied to the serving base station and the plurality of neighbor base stations.

24. The method as claimed in claim 23, wherein the predetermined coding scheme includes one of a Space Time Block Code (STBC) coding scheme and a Spatial Multiplexing (SM) coding scheme.

25. The method as claimed in claim 23, wherein the step of transmitting the signals by the serving base station to the mobile station further comprises transmitting signals which are identical to signals which are transmitted from the plurality of neighbor base stations to the mobile station, through frequency regions identical to frequency regions used by the plurality of neighbor base stations, when the predetermined frequency region allocation scheme is a simulcast scheme.

26. The method as claimed in claim 23, wherein the step of transmitting the signals by the serving base station to the mobile station further comprises transmitting signals identical to signals, which are transmitted from the plurality of neighbor base stations to the mobile station, through frequency regions which are different from frequency regions used by the plurality of neighbor base stations, when the predetermined frequency region allocation scheme is a diversity combining scheme.

27. The method as claimed in claim 23, wherein the step of transmitting the signals to the mobile station comprises transmitting signals which are different from signals which are transmitted from the plurality of neighbor base stations to the mobile station, through frequency regions which are different from frequency regions used by the neighbor base stations, when the predetermined frequency region allocation scheme is a data rate improvement scheme.

28. The method as claimed in claim 23, wherein the step of transmitting the signals by the neighbor base stations to the mobile station comprises transmitting signals which are identical to signals, which are transmitted from the serving base station to the mobile station, through frequency regions which are identical to frequency regions used by the serving base station, when the predetermined frequency region allocation scheme is a simulcast scheme.

29. The method as claimed in claim 23, wherein the step of transmitting the signals by the neighbor base stations to the mobile station comprises transmitting signals which are identical to signals which are transmitted from the serving base station to the mobile station, through frequency regions which are different from frequency regions used by the serving base station, when the predetermined frequency region allocation scheme is a diversity combining scheme.

30. The method as claimed in claim 23, wherein the step of transmitting the signals by the neighbor base stations to the mobile station comprises transmitting signals which are different from signals which are transmitted from the serving base station to the mobile station, through frequency regions which are different from frequency regions used by the serving base station, when the predetermined frequency region allocation scheme is a data rate improvement scheme.
